(19) United States
(12) Patent Application Publication
(10) Pub. No.: US 2009/0144824 A1
(43) Pub. Date: Jun. 4, 2009

(54) Integrated Protection Service Configured to Protect Minors

(75) Inventor: Jeffrey L. Rinek, Rescue, CA (US)

Correspondence Address: WINTHROP D. CHILDERS, 9855 FOX VALLEY WAY, SAN DIEGO, CA, 92127, US

(73) Assignee: Mr. Jeffrey L. Rinek, Rescue, CA (US)

(21) Appl. No.: 12/326,102

(22) Filed: Dec. 2, 2008

Related U.S. Application Data
(60) Provisional application No. 60/991,853, filed on Dec. 3, 2007.

(51) Int. Cl. G06F 21/00

(52) U.S. Cl. 726/22

(57) ABSTRACT

An integrated system configured to provide a safe environment for a minor is described. The system includes a training segment, a set-up segment, and a consulting segment. The training segment is configured to train parents and/or guardians of minors about dangers including those involving the internet. The set-up system is configured to help the parents or guardians establish tracking of the minor's internet activity. The consulting segment is configured to providing initial and ongoing consulting regarding particular threats or concerns associated with safety of the minor.

### RELATED APPLICATIONS

This non-provisional patent application claims priority to U.S. Provisional Application Ser. No. 60/991,853, Entitled “Integrated Protection Service Configured to Protect Minors” by Jeffrey L. Rinek, filed on Dec. 3, 2007, incorporated herein by reference under the benefit of U.S.C. 119(e).

### FIELD OF THE INVENTION

The present invention concerns a service dedicated to protecting minors from various threats. More particularly, the present invention concerns a way of identifying and responding to threats that may at least partly be indicated by a minor's internet activities.

### BACKGROUND

Minors have always faced threats to their safety and well being including internal and external threats. Internal threats include accidents, depression/suicide, and self-inflicted harm. External threats include abductions, assaults, and sexual offenders. With the advent of the internet and other societal changes, many of these threats appear to be getting more numerous.

For example, “internet predators” or adults that try to seduce minors using the internet have become widespread. Some of these predators are very sophisticated and hard to detect or identify. In many households, unsupervised children use the internet and are exposed to these criminals.

Along with these threats minors, particularly teenagers, experience severe depression. This can cause a minor to be more susceptible to the approach of predators or to attempted suicide or acts of violence.

Generally speaking, parents of minors do their best to interact with and train minors in a way that minimizes the threats and teaches them to avoid them. Unfortunately, in some households with single parents or with both parents employed, sufficient time to monitor and interact with minors may be lacking. What is needed is a way to help even preoccupied parents protect minors from external and internal threats.

### BRIEF DESCRIPTION OF THE FIGURES

FIG. 1 depicts an integrated protection service of the present invention and its relationship to guardians or parents, law enforcement, and the center for missing and exploited children.

FIG. 2 depicts the functions or segments of the integrated protection service of the present invention.

FIG. 3 depicts a method of the present invention in flow chart form.

FIG. 4 depicts an integrated protection service system that may form a portion of the present invention in block diagram form.

FIG. 5 depicts various portions of an integrated protection service system.

FIG. 6 depicts a method of analyzing a minor's internet and/or other system usage and issuing alerts when warranted.

FIG. 7 depicts a method of defining clusters using the integrated protection service system.

FIG. 8 depicts statistical clusters based upon information gathered from minors.

FIG. 9 depicts a method of fitting input information from a minor to a statistical cluster.

### DETAILED DESCRIPTION OF THE PREFERRED EMBODIMENTS

The foregoing refers to “minors” and “children”, and such terms refer to humans that are less than 18 (eighteen) years of age. As such, the terms “minors” and “children” are interchangeable in the context of the present invention. Also, the terms “parents” and “guardians” are used to refer to adults having minors in their care and hence will be interchangeable in the context of the present invention.

The foregoing refers to “sexual offenders”, “internet predators”, “preferential sex offenders”, and “sexual predators”. In general, these are all adults that pose a substantial risk to minors and often utilize the internet to victimize minors. The present invention applies to protecting children from all such adults.

The present invention also applies to protecting children from other threats such as the potential risks of depression or from other children that may pose a threat. The present invention applies to all threats for which the service and/or system of the present invention may be beneficial.

The present invention and its embodiments include and enable an integrated protection service that protects minors from aforementioned threats. Additionally, that children experience crises in other areas of their lives, such as school, friends, etc., can also be identified as a collateral benefit to this invention. This integrated protection service is unique in that it may include highly synergistic functions such as training, consulting, set-up, monitoring, analysis, and response. This service enables preoccupied parents to act proactively against threats to their children before those threats reach a critical threshold.

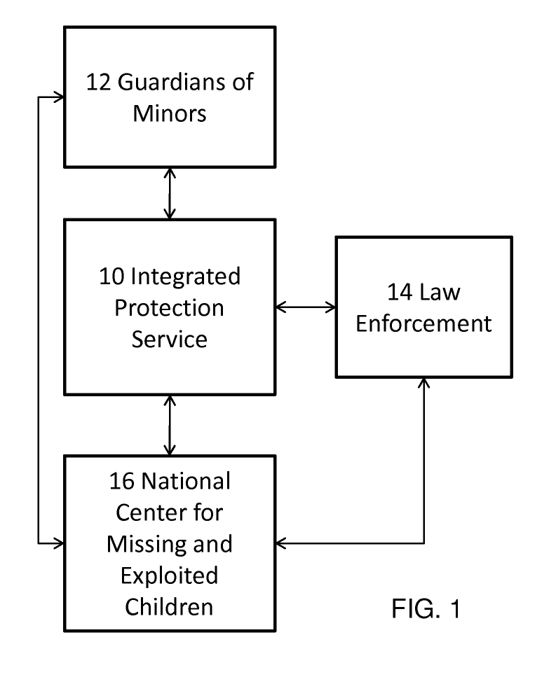

A service according to the present invention is depicted in block diagram form in FIG. 1. IPS (integrated protection service) 10 is in communication with guardians or parents of minors 12, law enforcement 14, and other organizations such as the NCEMC (national center for exploited or missing children) 16. As may be appreciated, IPS 10 may be in communication with additional organizations as well.

IPS 10 works with and communicates with parents or guardians 12 to detect areas of concern that may affect minors or children. IPS 10 works with law enforcement 14 to enable apprehension of adults who pose threats to minors. IPS 10 works with the NCEMC 16 to share database information and to identify individuals who are approaching minors in a potentially illegal or threatening way.

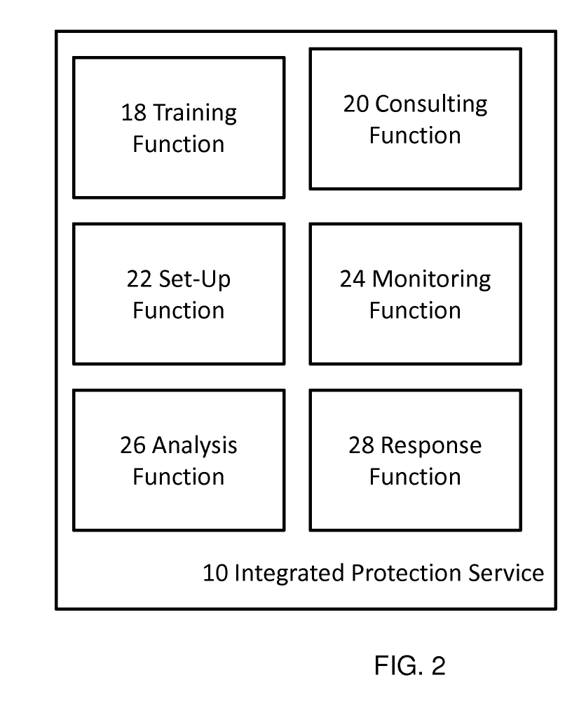

FIG. 2 depicts IPS (integrated protection service) 10 in block diagram form, illustrating various functions or segments of IPS 10. Functions or segments may include training 18, consulting 20, set-up 22, monitoring 24, analysis 26, and/or response 28. Descriptions of these segments follow although it is to be understood that functions of the segments may be overlapping and that this description of the segments is an exemplary embodiment of the invention.

Training segment 18 provides initial training for parents or guardians of minors. Segment 18 trains parents or guardians as to the dangers facing minors including internet predators, sexual exploitation, abductions, and depression to name a few. The training segment 18 helps guardians to identify signs of these threats and actions to take when threats are observed. The training segment 18 also trains guardians how to use internet monitoring software and how to work with the various segments of IPS and other organizations to assure protection of the minors under their care.

Consulting segment 20 provides consulting related to the specific concerns a parent may have. When a parent initially engages IPS 10, the consulting segment 20 may listen to specific concerns parents may have concerning their child. Consulting segment 20 then may customize any or all functions of IPS 10 pursuant to those concerns. Consulting segment 20 also provides consulting to parents for concerns or observations that may arise while the parents engage IPS 10.

Set-up function 22 provides parents with materials, information, software, and assistance for monitoring their children. Set-up function 22 may also help parents with software installation and other tasks involved in establishing engagement with IPS 10. In particular, set-up function initiates monitoring of a minor's internet activities.

Once parents have engaged IPS 10, monitoring and observing their child's activities may be primarily their responsibility. The most important factor for child safety is the presence of committed and involved parents. At the same time, monitoring segment 24 may also provide direct monitoring of a child's on-line and other activities. Monitoring function may provide this monitoring by gathering information from one or more “reporting sources”. Examples of reporting sources include the subject child, the child's family, the child's friends, the child's school, the child's classmates, law enforcement, social services, a government entity, or from the computer the subject child uses. More details of reporting sources and types of inputs received are discussed infra.

Analysis function 26 takes inputs or information from the reporting sources and creates a risk profile for the subject child. This risk profile may be computer generated or it may be assembled manually by a professional within the IPS 10. The risk profile is indicative of the type and magnitude of risks for the child.

Response function 28 responds to a risk profile or an update of a risk profile for a given child. When the risk profile is indicative of a sufficiently high risk to a child, the response function may respond by contacting the parents 12, law enforcement 14, or another entity such as NCMEC 16.

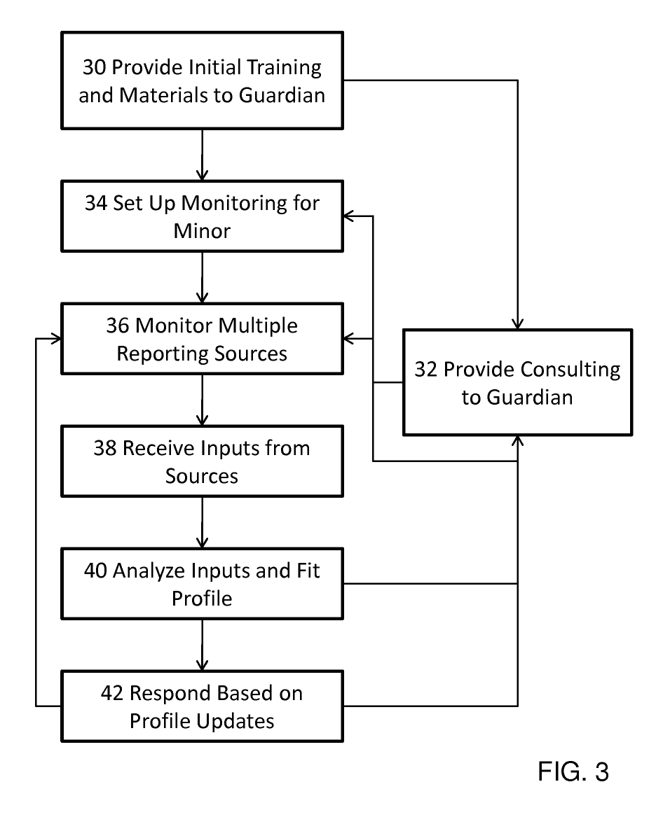

A method according to the present invention is depicted in flow chart form in FIG. 3. According to 30, IPS 10 provides initial training and materials to a parent or guardian of minors. These materials may include monitoring software and printed training materials for example.

During initial training, parents will learn about risks to their children, how to monitor a child's behavior, what elevated risk indicators to look for, and how to respond to the indications of elevated risk. As part of this training, parents may learn about the behavior and typology of preferential sex offenders so that they will be able to recognize threats and when to seek help. Parents may also be provided training and information concerning high risk teen or minor behavior.

According to 32, consulting is provided to parents. This may occur initially during training and may include having the parents describe their concerns to IPS 10 consultants. For example, a parent may describe their child's self-destructive behavior to an IPS 10 consultant. The consultant will then provide the parents with advice and a monitoring and response plan that specifically addresses this concern.

According to 34, monitoring is set up. This may include installation and activation of internet monitoring software. According to 36, one or more reporting sources are monitored. This includes monitoring of the internet activity according to software installed during step 34. According to 38, inputs from various reporting sources are received by IPS 10.

According to 40, inputs from monitoring software and/or other reporting sources are analyzed and a risk profile is determined. In one embodiment, the risk profile is based on statistical clustering technology. In one embodiment, the risk profile is based upon a manual evaluation of the inputs. Based upon elevated risks indicated by the risk profile, IPS 10 may provide consultation to parents according to 32.

According to 42, IPS responds to a new or updated risk profile. This may include closer scrutiny of a child's activity is suspicious behavior is detected. If the risk is high enough, the NMEC 16 or law enforcement 14 may be contacted.

In one embodiment, an alarm or an alert is issued according to 42. The alarm may alert parents, law enforcement, or others according to an elevated risk profile. The alert may come in the form of a manual or automated phone call, a text message, an email, or an instant message to name a few examples.

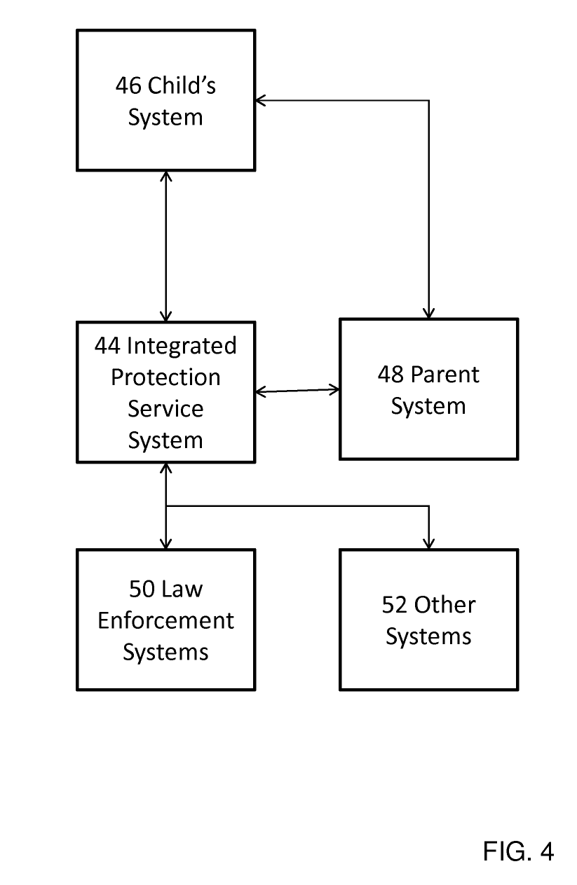

IPS (integrated protection service) may include an IT (information technology) system 44 that provides any or all of the functions depicted in FIG. 2. According to FIG. 4, IPS 10 includes an IPSS (integrated protection service system) 44 that is linked into various other IT systems or computers or telephones or cellular phones or other electronic devices including a minor system 46, a parent system 48, a law enforcement system 50, and a other systems 52 such as a NCMEC system.

IPSS 44 may be configured to directly monitor a child's internet activity by receiving information from minor system 46. IPSS 44 may also be configured to communicate concerns, monitoring results, and other information to and from parent system 48. IPSS 44 may also be configured to communicate information to and from police systems 50 and other systems 52.

Minor system 46 may be a personal computer utilized by the child. It may also be a cellular phone 46, a laptop 46, a palm computer 46, or any other device used by a minor that can couple to a computer network, a cellular phone network, or any other wired or wireless communication system. Parent system 48 may be a personal computer 48, a cellular phone 48, a land telephone 48, a laptop computer 48, or any other electronic information related device 48 utilized by parents or guardians.

In a preferred embodiment, the computer and internet usage information indicative of the use of child system 46 is transmitted to parent system 48 and to IPSS 44. The parents can contact IPS 10 in the event that activity is seen that generates concern. At the same time, the usage information is securely stored within IPSS 44. IPSS 44 is configured to securely store the usage information in case the child system 46 or parent system 48 becomes compromised. As part of this preferred embodiment, IPSS 44 is configured to analyze the usage information to determine whether there is a cause for concern. If there is a cause for concern, IPSS 44 is configured to send an alert to parent system 48. In a preferred embodiment, IPSS is configured to communicate alerts to multiple devices including two or more of a cellular phone, a land telephone, a laptop computer, a parent system 48, a law enforcement system 50, and other systems 52.

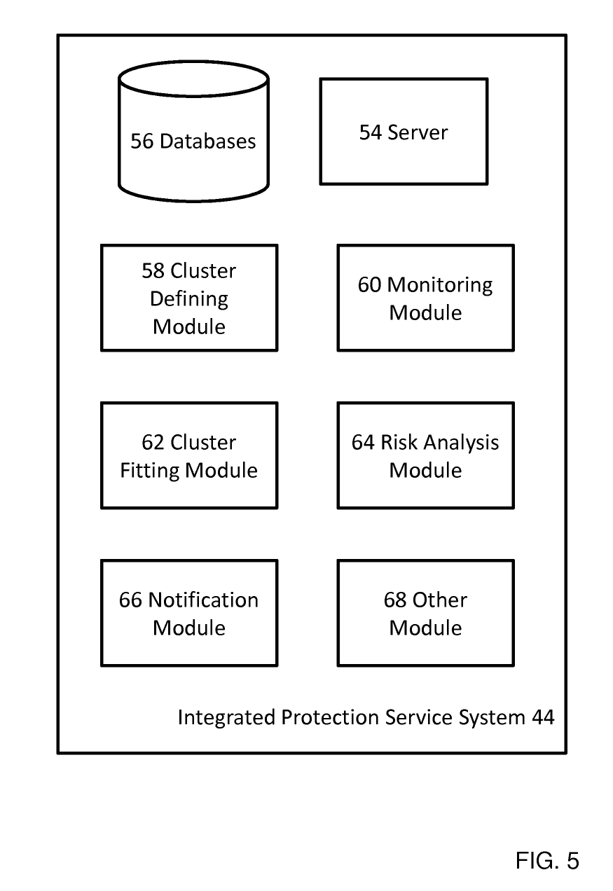

FIG. 5 depicts an exemplary IPSS 44 including server 54, databases 56, and software modules 58-68. Server 54 is configured to manage communication between IPSS 44 and other IT systems. There may be other components and functions of IPSS 44 in addition to what is described herein. For example, IPSS 44 may include remote computers, laptops, palmtops, cellular phones, or other devices that are configured to communicate with server 54.

Database 56 stores information such as information from various reporting sources and profiles for minors. Database 56 may also store information received from law enforcement systems 50 and other systems 52 indicative of characterizations or profiles related to various offenders or suspects that may be pertinent to identifying threats to minors. Database 56 may also store the latest information that enables more effective analysis of potential or existing threats or elevated risk profiles. In a preferred embodiment, database 56 is configured to store internet and other usage information indicative of the record of a minor's use of minor system 46.

Cluster defining module 58 is configured to take information from reporting sources for numerous minors and to fit that information to data clusters or statistical clusters. An exemplary statistical clustering technique is referred to a “K-means” clustering method, although there are other statistical clustering methods. These clusters may define or be closely associated with a risk profile for a given minor. Once the clusters have been defined, they correlate various inputs related to minors to various identities and magnitudes of elevated risks that confront the minors.

Monitoring module 60 is configured to take information from various reporting sources and to store that information in database 56. Monitoring module may also parameterize inputs or to give them values that can be used for statistically clustering purposes.

Cluster fitting module 62 is configured to take information or inputs for a given minor and to fit that information to a given cluster that has been defined by cluster defining module 58. The particular cluster may define or be associated with the risk profile for the minor. In some situations, a given minor may fit more than one cluster.

Risk analysis module 64 is configured to determine what risks face a given minor and what appropriate responses may be. Risk analysis module may utilize the risk profile and/or it may directly analyze information from monitoring module 60. Notification module 66 generates a warning or alert when one or more risks for a given minor require attention. That warning may be one or more of an electronic mail, a text message, or a computer generated phone call.

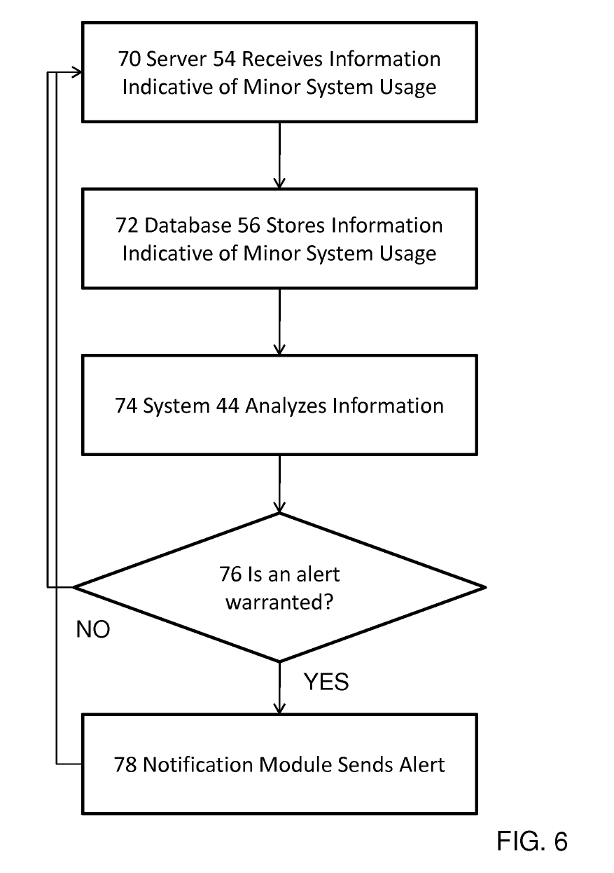

FIG. 6 depicts an exemplary operation of IPSS 44. According to 70, server 54 receives information indicative of the usage of minor system 46. According to 72, database 56 stores the information. In the event that minor system 46 becomes erased, damaged, or compromised, database 56 still provides a usage record from minor system 46.

According to 74, system 44 analyzes the information indicative of the usage record. This analysis may make use of one or more of various software modules, including monitoring module 60, cluster fitting module 62, and risk analysis module 64.

According to 76, risk analysis module determines whether an alert is warranted and, if so, what level of alert is warranted. If an alert is warranted, notification module transmits an alert according to 78. According to 78, the alert is transmitted to one or more of a parent system 48, a law enforcement system 50, another system 52, a personal computer, a laptop computer, a cellular phone, a land telephone, or an electronic device that is coupled to a wireless or wired network.

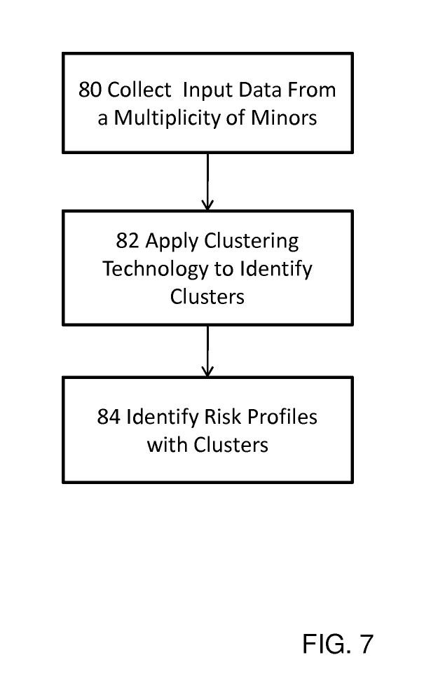

FIG. 7 depicts a method of defining statistical clusters based upon risk factors for minors. According to 80, input data is collected for a large number of minors. In one embodiment, this input data is based upon internet usage. This input data may also be based information from various reporting sources and may include non-internet behaviors or confirmed contacts by adult offenders.

According to 82, clustering technology is applied to identify statistical clusters for the input data. A statistical cluster is defined as a region of a vector space wherein certain inputs or factors tend to have very similar values and hence are clustered together. These clusters may correlate various observations such as internet usage data with elevated risk indicators such as depression or the influence of adult offenders.

According to 84, risk profiles are identified with particular clusters. The risk profiles are indicative of an estimated or computed type and magnitude of risk. When a minor has input data that fits a given cluster, this is indicative of the risk profile that is defined by or associated with that cluster.

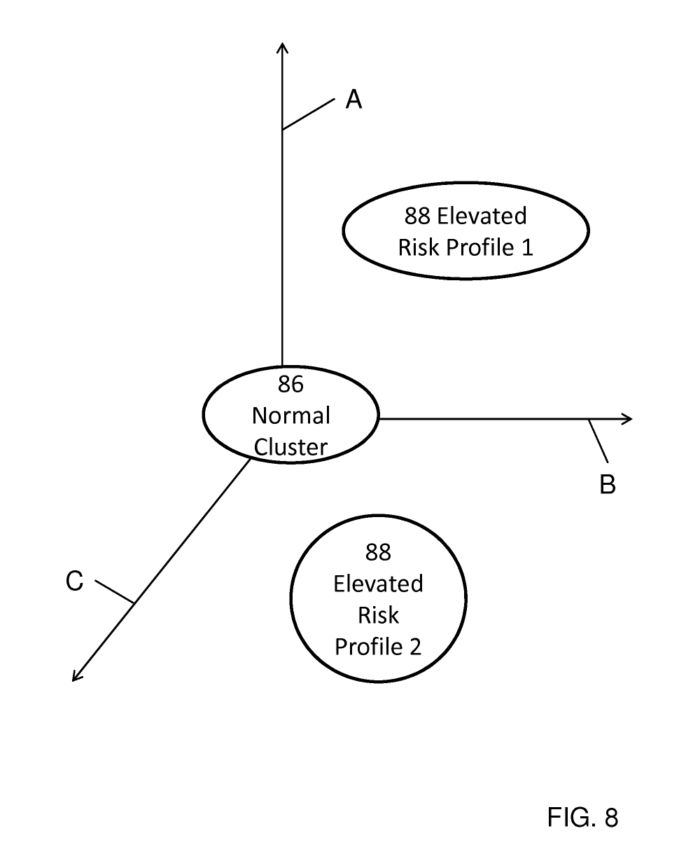

FIG. 8 depicts statistical clusters that may be a result of the method depicted in FIG. 7. Axes A, B, and C depict factors used for clustering. For example, axis A may depict a degree to which a minor uses words that might relate to self-destructive behavior. Axis B may depict a degree to which a minor accesses social networking sites. Axis C may depict a degree to which a minor accesses or attempts to access higher risk web sites. In practice there are probably more than three factors; FIG. 8 depicts three factors for illustrative simplicity.

Three clusters are identified—a normal cluster 86 and elevated risk clusters 88. The normal cluster 86 would be indicative of a minor having a normal level of risk without a single major risk factor standing out. Elevated risk clusters 88 would be each be indicative of a combination of factors that are indicative high risk behavior. Clusters 88 define elevated risk profile 1 and elevated risk profile 2.

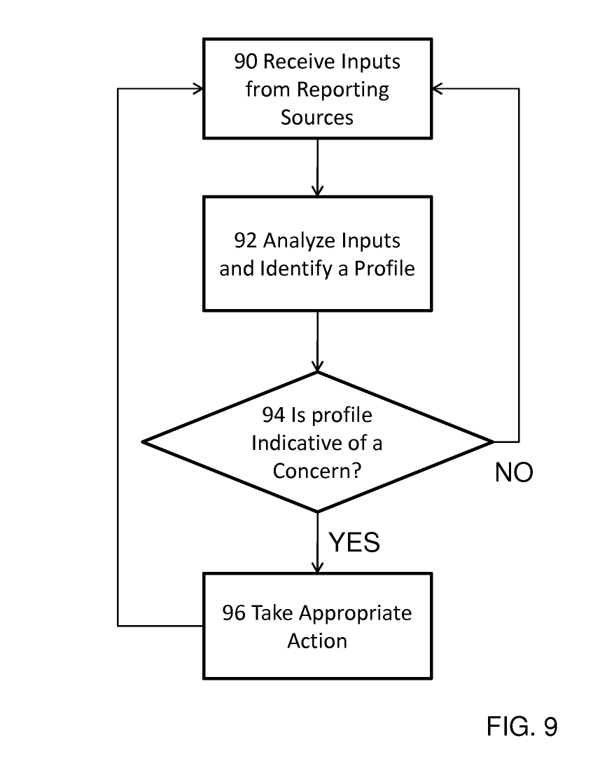

FIG. 9 depicts a method of determining and using a risk profile for a given minor to be utilized by IPSS 44. According to 90, inputs are received from various reporting sources, such as the minor's internet usage. According to 92, the inputs are analyzed to identify a profile for the minor. In one embodiment, these inputs are analyzed manually by a professional. In one embodiment, the inputs are analyzed and fit to a statistical cluster via cluster fitting module 62.

According to 94, a risk assessment is performed to determine a level of concern for the minor based upon the profile. If the concern level is high enough to warrant a response, then this takes place according to 96. According to 96, an alert or alarm may be generated. In one embodiment, the alert is generated by IPSS 44 and communicated to another device such as a parent system 48, a law enforcement system 50, another system 52, a telephone, a laptop computer, a desktop computer, a PDA a mobile device, or an electronic device that is coupled to a wired or wireless network.

### Reporting Sources:

As discussed supra, various reporting sources are monitored by parents 12, by integrated protection service 10, and/or by integrated protection service system 44. The reporting sources provide inputs that can then be analyzed to determine risk profiles and/or an appropriate response. The numbers indicated below indicate clusters 1-7 that are all clusters indicative of an elevated risk profile.

Inputs from Reporting Source Including One or More of Subject Child or Minor:

| Cluster | Input Information |
|---|---|
| 7 | Child reports receipt of unsolicited sexual email or photograph |
| 7 | Child reports receipt of unsolicited sexual instant message/ |
| | instant communication |
| 7 | Child reports receipt of unsolicited mail from the United States |
| | Post Office |
| 7 | Child reports receipt of unsolicited contact via United States |
| | Post Office |
| 8 | Child reports receipt of unsolicited contact outside of the home |
| 8 | Child reports unsolicited sexual contact outside of home |
| 9 | Child reports observed sexual contact determined to be of an |
| | illegal nature |
| 9 | Child reports contact from a friend reporting sexual behavior |
| | of an illegal nature |
| 10 | Child reports sexual molest by a family member, parent, sibling, |
| | extended family member |
| 11 | Child reports sexual molest by a non related, but familiar |
| | adult, or child |
| 12 | Child reports sexual molest by an unknown person |

Inputs from Reporting Source Including One or More of Minor's Family or Parent or Guardian or Friends:

| Cluster | Input Information |
|---|---|
| 1, 2, 3, 4, 5 | Child begins spending inordinate amount of time on the computer. |
| 1, 2, 3, 6 | Child become secretive about computer activity (e.g. extensive |
| | password protection utilized by the child) |
| 1, 2, 3 | Child develops new and advanced skills operating the computer. |
| 1, 2, 3, 4, 6 | Increasing tendency to use the telephone, cell phone, web camera, |
| | text messaging while on the computer |
| 1 | Child begins withdrawing from family relationships and family intimacy. |
| 1 | Child withdraws from friends and social activities |
| 1 | The child's siblings will notice a behavioral change. |
| 1 | Child changes their social environment to include abandoning friends. |
| 1, 2, 6 | Child may exhibit a new interest in their appearance, or level of |
| | maturity. |
| 1 | The child may incorporate into their conversation new names of |
| | persons not previously known. |
| 1, 2, 3 | Child may receive unusual mail, or packages. |
| 1, 6 | The child may receive phone calls from individuals not known to the family |
| 1, 2, 3, 4 | Child may add, and install peripheral devices for the computer. |
| 1 | The child may display a new interest in technology |
| 1, 6 | The child may ask for a cell phone, new cell phone, or cell phone |
| | with specific features |
| 1 | The child may display an increase of interest in sexual matters, or |
| | become sexually active. |
| 1 | The child may act out sexually with siblings, family, or friends |
| 1, 4, 5, 6 | Child starts sleeping over away from home |
| 1, 4, 5, 6 | The child might obtain luggage, or travel items |

Inputs from Reporting Source Including One or More of Child's Friends Classmates or School

| Cluster | Input Information |
|---|---|
| 1, 2, 3, 4, 6 | Child displays increased use of phone, cell phone, |
| | text messaging, etc. |
| 1 | Child withdraws from activities, relationships |
| 1 | Child becomes secretive |
| 1, 2, 6 | Child changes appearance relating to sexual maturity |
| 1 | Child mentions names of friends not previously known |
| 1 | Child may express a new level of interest in technology |
| 1 | Child may act out in sexual manners, become more |
| | physically involved |
| 6 | Child is observed to be with friends not previously |
| | known nor from the local area |
| 1, 2, 3, 4, 5, 6 | Child may display, or be observed with new jewelry, or |
| | unexplained gifts |
| 1, 4, 5, 6 | Child's school work suffers, child disengages from |
| | academics |
| 1, 2, 3, 4, 5, 6 | Child's behavior may become aggressive, |
| | violent, belligerent |
| 1, 2, 3, 4, 5, 6 | Child may express a change in self image |

Inputs from Reporting Source Originating from Outside the Home, or Child's Known Environment

| Cluster | Input Information |
|---|---|
| 1, 2, 3 | Child is contacted by social services, law enforcement, |
| | or other government entity |
| 1, 5, 6 | Child is interviewed at school, or at home by law |
| | enforcement/child is a witness or victim |
| 1, 5, 6 | Child's identity becomes known by virtue of reporting |
| | by third party, investigation |
| 1, 5, 6 | Child is taken into custody |
| 1, 5, 6 | Child is admitted to a hospital |
| 1, 5, 6 | Child becomes missing to include running away |

Inputs from Reporting Source Including One of a Computer, Cell Phone, PDA, Laptop, Palmtop, or Other Device Accessed by a Minor:

| Cluster | Input Information |
|---|---|
| 1, 2, 3, 4 | Child may install new programs for purposes of protecting or |
| | destroying information |
| 1, 2, 3, 4 | Child may install new program providing enhanced communication ability |
| 1, 2, 3, 4 | Internet activity will develop an unexplained focus, or intensity |
| | toward certain Internet sites/chat rooms |
| 1, 2, 3, 4 | Additional Internet and computer activity toward downloading, |
| | uploading pictures, and video |
| 1, 2 | The child will obtain, or author stories and fantasies |
| 1, 2 | The child's stories and fantasies will incorporate themes of |
| | romance, and sexual encounters |
| 1, 2, 3, 4, 5, 6 | The child may develop new contacts with people not known to the |
| | child's family |
| 1, 2, 3 | A review of the computer may review a dramatic increase of |
| | pictures and videos |
| 1, 2, 3 | The computer may be configured for greater autonomy |
| 1, 2, 3 | Screen savers may change |
| 1, 2, 3, 4, 5, 6 | The child may follow a strict time regimen to be present at the |
| | computer at certain times |
| 1, 2, 3, 4 | There may be a dramatic increase in email, instant messaging, or |
| | message board participation |
| 1, 5, 6 | The child may begin tracking transportation services such as bus, |
| | train, or air schedules |
| 1, 5, 6 | There may be research about different areas of the country or countries |
| 1, 5, 6 | The child may initiate registrations on different travel related sites |

The following are two scenarios that are actual or similar to tragedies that have happened involving minors. After the scenarios are described, the manners in which the Integrated Protection Service 10 may have been employed are described. The integrated protection service 10 is configured to prevent these tragedies using multiple methodologies.

### Scenario 1

A 13 year old girl thought she had made a new friend in cyberspace when an allegedly cute teenage boy named Ken contacted her on her MySpace account and began exchanging messages with her. Jill was 13 years old at the time her correspondence with “Ken” began. Jill was very excited about her new cyber boyfriend; however, her mom was very concerned about the online relationship. Her mom was very worried that the family had never met Ken. Ken claimed to be new to the area and he did not have a phone. The online relationship continued. The relationship continued for over a month before Ken started making derogatory remarks to Jill. Ken told Jill that he had heard that she was cruel to her friends and he called her fat and a slut.

The day after Ken ended the relationship, Jill committed suicide. Her family learned later that Ken was a factitious character invented by family members of a neighborhood family that included a former girlfriend of Jill's. Apparently, Jill and her neighborhood girlfriend had a falling out. In an attempt to punish Jill, the neighborhood family decided to create a factitious boy that would become Jill's online boyfriend. Once they were confident that Jill was in love, they would call Jill derogatory names and end the relationship abruptly.

Had IPS (Integrated Protection Service) been Employed

IPS 10 would have detected the online relationship and would have alerted Jill's parents. In this case, Jill's mom was aware of the relationship, however, she was not aware of the potential dangers. IPS, through its training and consulting functions, would have outlined the dangers of anonymous online relationships Jill's parents. In addition, by working with the National Center for Missing and Exploited Children (NCMEC) and the FBI, IPS would have identified Ken as a fictitious person. Although Jill would have found this information devastating, she probably would not have killed herself. This is particularly true in light of the fact that an investigation would have revealed that Ken was contrived by the neighborhood family she was already having problems with.

The analysis and response functions of IPS 10 would have also been able to fit the situation with an elevated risk profile. Risk analysis module 64 would interpret an “unknown” correspondent and the types of words and phrases indicating emotional content with an elevated risk. The notification module would have issued an alert to Jill's parents indicative of the elevated risk and a need to verify the identity of the correspondent.

### Scenario 2

A 15 year old girl living with her family in Chicago, III was approached by a 17 year old boy living in Chico, Calif. They begin an online dialog and soon fell in love. The 15 year old girl answered very personal and sexually oriented questions posed by her new online boyfriend. The questions escalated into cyber sex. As the novelty of cyber sex waned, they decide to meet. It was mutually agreed that the 15 year old girl should be the one to travel. They picked a three day weekend and the boyfriend purchased airline tickets. The 17 year old boyfriend sent the airline tickets to his girlfriend. (Most of the travel dialog was done over the internet.) The girlfriend flew on United Airlines to Sacramento, Calif. and the boyfriend met her in the parking lot. To her surprise, he appeared much older than 17. In fact, he was 32. Nevertheless, she decided to accompany him to Chico for the three day weekend. During the long weekend, she learned many more things about her boyfriend including that he was not 17 years old, and he had only one leg. With all this new information, she stayed and had sex with him. After the three day weekend was over, he gave her a ride back to the airport in Sacramento and she returned home.

During her absence, her parents learned that their 15 year old daughter was not at a weekend camping trip as she reported. They became panicked. Believing that their daughter had been abducted or had run away, Chicago FBI responded to their aid and began searching her computer. Soon the FBI discovered that she had been having an online relationship with someone claiming to be a 17 year old boy. The FBI also found that the 17 year old boyfriend sent the victim airline tickets. Unfortunately, the Sacramento FBI intercepted the victim at the Sacramento airport on her way home after the three day weekend. The suspect was prosecuted for the sexual assault and for enticing a minor to cross state lines for the purpose of sex.

Had IPS been Employed

Had the parents had monitoring software installed on their daughter's computer, it is very likely the online relationship would have been detected. The parents would have been counseled by IPS 10 training and consulting functions on the inherent dangers of such a relationship. As the relationship continued with cyber sex, again IPS would have alerted the parents of the dangers of this type of activity. By working with the National Center for Missing and Exploited Children (NCMEC) and law enforcement, IPS Counselors would have attempted to identify the true identity of the “17 year old boyfriend.” IPS may have also detected the plans for the 15 year old girl to travel from Chicago to Sacramento. Once the parents realized that their daughter was missing, IPS Counselors would have reviewed the family account and quickly identified her travel plans. The victim may have been intercepted prior to reaching the sexual offender and thus preventing the sexual assault.

The IPSS (Integrated Protection Service IT System) 44 would very likely have detected this early enough to prevent the tragedy. The cluster fitting software would have quickly recognized parameters that would fit this scenario including: (1) communication with an unidentified correspondent, (2) remote location of correspondent, (3) sexual words and phrases, (4) cyber sex, (5) data obtained on travel, (6) data obtained on travel corresponding to the remote location of the correspondent, etc. The parents may have been alerted quite early enough to have law enforcement take the place of the girl in the internet exchanges. The criminal would have been apprehended without the girl being in danger.

What we claim is:

1. An integrated protection system dedicated to the safety of minors using the internet comprising:
a training segment configured to train a parent or guardian of a minor about internet risks and elevated risk factors related to minors;
a set-up segment configured to enable initiation of tracking of internet usage for the minor; and
a consulting segment configured to provide initial and ongoing consulting with the parent or guardian to address specific threats and concerns.

2. The integrated protection system of claim 1 wherein the integrated protection system includes a computer system that is configured to monitor the internet usage and wherein one or more of the training segment, the set-up segment, and the consulting segment includes a software module that resides upon the computer system.

3. The integrated protection system of claim 1 further comprising a monitoring segment configured to monitor the internet usage, and an analysis segment configured to determine a risk profile based upon the internet usage.

4. The integrated protection system of claim 3 further comprising a response segment configured to automatically generate an alert when the risk profile is indicative of an elevated risk to the minor.

5. The integrated protection system of claim 4 wherein the response segment is configured to transmit the alert to one or more of a parent system, a law enforcement system, a computer system, a laptop computer, a cellular phone, a land telephone, or an electronic device coupled to a wired or wireless network.

6. The integrated protection system of claim 1 further comprising a monitoring segment configured to monitor a reporting source providing inputs indicative of risk factors for the minor.

7. The integrated protection system of claim 6 wherein the reporting source is a plurality of different reporting sources.

8. A method provided by an integrated protection service whose overall function is to provide protection to a minor from various threats comprising:
providing an integrated protection system;
providing initial training and materials to a parent or guardian of the minor, the training and materials enabling the parent or guardian to recognize aberrant events indicative of elevated risks to the minor;
receiving information at the integrated protection system that is indicative of an elevated risk related to the minor; and
providing consulting to the parent or guardian based upon the information.

9. The method of claim 8 wherein the materials include software configured to:
(1) track internet usage of the minor and
(2) provide information to the integrated protection system indicative of the internet usage.

10. The method of claim 8 wherein the integrated protection system is a computer system that is linked to a minor system used by the minor and configured to automatically monitor internet usage of the minor.

11. The method of claim 8 wherein the integrated protection system is a computer system that is linked to a parent system operated by the parent or guardian and configured to automatically receive information indicative of internet usage of the minor from the parent system.

12. The method of claim 8 further comprising analyzing the information to determine a risk profile for the minor.

13. The method of claim 8 further comprising receiving specific initial concerns from the parent or guardian and then adapting the consulting based upon the specific initial concerns.

14. The method of claim 8 wherein receiving information includes receiving inputs from a plurality of different reporting sources.

15. The method of 8 wherein receiving information includes receiving information from two or more of the minor, the parent or guardian of the minor, school officials, law enforcement, social services, a government entity, an internet usage record, a cellular phone record.

16. An integrated protection system dedicated to the well being and safety of minors comprising:
a training segment configured to train a parent or guardian about risks to a minor under their care;
a set-up segment configured to initiate monitoring of a reporting source that provides inputs indicative of elevated risks to the minor; and
an analysis segment configured to analyze the inputs and to determine an appropriate response when a sufficiently elevated risk to the minor is indicated, wherein the integrated protection system includes a server configured to communicate with a parent system and wherein one or more of the training system, the set-up segment, and the analysis segment is a software module residing on the integrated protection system.

17. The integrated protection system of claim 16 further comprising a monitoring segment configured to receive the inputs.

18. The integrated protection system of claim 16 further comprising a response segment configured to generate an alert based upon the appropriate response.

19. The integrated protection system of claim 16 wherein the reporting source includes a plurality of reporting sources.

20. The integrated protection system of claim 19 wherein the plurality of reporting sources includes two or more of the minor, the parent or guardian of the minor, school officials, law enforcement, social services, a government entity, an internet usage record, a cellular phone record.
